(19) United States
(12) Patent Application Publication
(10) Pub. No.: US 2021/0356897 A1
(43) Pub. Date: Nov. 18, 2021

(54) IMAGE READING APPARATUS AND IMAGE FORMING APPARATUS

(71) Applicant: CANON KABUSHIKI KAISHA, Tokyo (JP)

(72) Inventors: Takayuki Fukushima, Ibaraki (JP); Takuya Yamaguchi, Chiba (JP)

(21) Appl. No.: 17/319,985

(22) Filed: May 13, 2021

(30) Foreign Application Priority Data
May 18, 2020 (JP) 2020-086985

(51) Int. Cl. G03G 15/00; G03G 21/16

(52) U.S. Cl. CPC G03G 15/607; G03G 21/1604; G03G 15/6552; G03G 15/6567

(57) ABSTRACT

An image reading apparatus includes a placement surface, a feeding unit, a reading unit, and an indication portion. The feeding unit feeds a placement surface placed sheet in a feeding direction. The reading unit reads an image on the fed sheet. The indication portion indicates a position where the sheet is to be placed on the placement surface and a sheet center position in a sheet width direction perpendicular to the feeding direction. The indication portion includes a first portion on one side in the sheet width direction of the center position and a second portion on another side in the sheet width direction of the center position. The distance from the center position to a first portion end on the one side is the same as a distance from the center position to a second portion end on the other side.

### BACKGROUND

### Field

The present disclosure relates to an image reading apparatus that reads an image on a fed sheet and an image forming apparatus provided with the image reading apparatus.

### Description of the Related Art

An image reading apparatus, such as a scanner or an image reading apparatus provided in a copying machine or the like, feeds a sheet placed on a placement unit and reads an image on the sheet by a reading unit. According to Japanese Patent Application Laid-Open No. 2006-103944, a scale capable of measuring a width of a sheet is provided to accommodate sheets having non-standard sizes.

A configuration discussed in Japanese Patent Application Laid-Open No. 2006-103944 does not consider enabling a user to easily recognize a position of a sheet to be placed. Thus, operability is not favorable at the time of placing a sheet.

### SUMMARY

The present disclosure is directed to providing an image reading apparatus in which operability in placing a sheet is improved.

According to an aspect of the present disclosure, an image reading apparatus includes a placement surface on which a sheet is to be placed, a feeding unit configured to feed the sheet placed on the placement surface in a feeding direction, a reading unit configured to read an image on the sheet fed by the feeding unit, and an indication portion provided at a position different from the placement surface and configured to indicate a position at which the sheet is to be placed on the placement surface, wherein the indication portion indicates a center position of the sheet to be placed on the placement surface in a sheet width direction perpendicular to the feeding direction, wherein the indication portion includes a first portion extending in the sheet width direction on one side in the sheet width direction of the center position and a second portion extending in the sheet width direction on another side in the sheet width direction of the center position, and wherein a distance from the center position to an end of the first portion on the one side is the same as a distance from the center position to an end of the second portion on the other side.

Further features of the present disclosure will become apparent from the following description of exemplary embodiments with reference to the attached drawings.

### BRIEF DESCRIPTION OF THE DRAWINGS

FIG. 1 is a cross-sectional view of an image forming apparatus according to the present disclosure.

FIG. 2 is a top view of an image reading apparatus according to the present disclosure.

FIG. 3 is a perspective view of the image reading apparatus according to the present disclosure.

FIG. 4 is an enlarged view of an opening/closing cover according to the present disclosure.

FIG. 5 is a cross-sectional view the image reading apparatus according to the present disclosure.

FIG. 6 illustrates a setting position indication portion.

FIG. 7 illustrates a modification of the setting position indication portion.

FIG. 8 illustrates a modification of the setting position indication portion.

FIG. 9 illustrates a modification of the setting position indication portion.

FIGS. 10A and 10B each illustrate attachment of a setting position indication label.

FIG. 11 illustrates the opening/closing cover to which a concealing label is attached.

### DESCRIPTION OF THE EMBODIMENTS

Exemplary embodiments of the present disclosure will be described in detail below with reference to the attached drawings.

### <Configuration of Image Forming Apparatus 101>

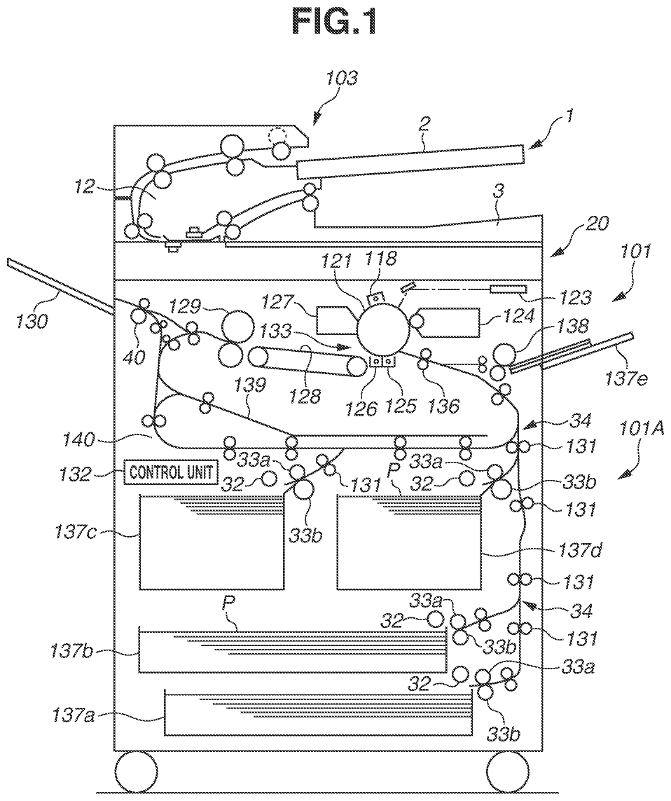

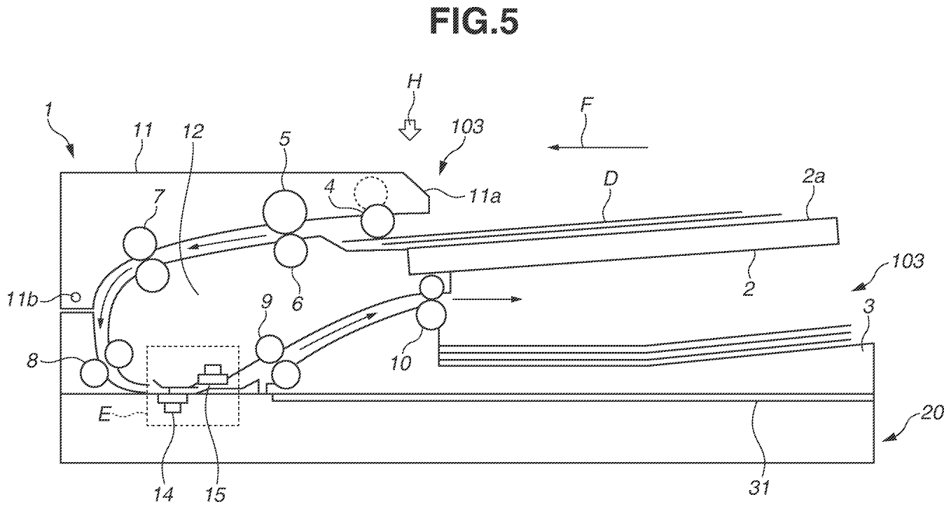

A schematic configuration of an image forming apparatus 101 according to the present exemplary embodiment is described with reference to FIG. 1. As illustrated in FIG. 1, the image forming apparatus 101 includes an image reading apparatus 103 and an apparatus main body 101A, which forms an image on a recording medium based on an image read by the image reading apparatus 103. The image reading apparatus 103, which is arranged above the apparatus main body 101A, includes a scanner unit 20 and an auto document feeder (ADF) 1 as described in detail below and optically scans a document D to read image information. The document D (refer to FIG. 5) includes paper such as a sheet and an envelope, a plastic film such as an overhead projector sheet, and a fabric sheet. The image information converted into an electrical signal by the image reading apparatus 103 is transferred to a control unit 132, which is illustrated in FIG. 1, provided in the apparatus main body 101A.

The apparatus main body 101A includes an image forming unit 133 that forms an image on a sheet P as a recording medium and a sheet feeding unit 34 that feeds the sheet P to the image forming unit 133. The sheet feeding unit 34 includes sheet storage units 137a, 137b, 137c, and 137d, which can respectively store sheets having different sizes. The sheets stored in each sheet storage unit are picked up by a pickup roller 32, separated one by one by a feed roller 33a and a retard roller 33b, and transferred to a corresponding pair of conveyance rollers 131. The sheet P is sequentially transferred to a plurality of pairs of the conveyance rollers 131 arranged along a sheet conveyance path and thus conveyed to a pair of registration rollers 136.

The sheet P loaded on a manual feed tray 137e by a user is fed to an inside of the apparatus main body 101A by a feeding roller 138 and conveyed to the pair of registration rollers 136. The pair of registration rollers 136 stops the sheet P at a leading end to correct skew feeding and restarts conveyance of the sheet P in accordance with progress of an image forming operation, which is a process for forming a toner image by the image forming unit 133.

The image forming unit 133 that forms an image on the sheet P is an electrophotographic type image forming unit provided with a photosensitive drum 121 as a photosensitive member. The photosensitive drum 121 can rotate along a conveyance direction of the sheet P, and a charger 118, an exposure device 123, a development device 124, a transfer charger 125, a separation charger 126, and a cleaner 127 are arranged around the photosensitive drum 121. The charger 118 uniformly charges a surface of the photosensitive drum 121. The exposure device 123 exposes the photosensitive drum 121 to light based on the image information input from the image reading apparatus 103 and the like and forms an electrostatic latent image on the photosensitive drum 121.

The development device 124 stores developer including toner and supplies charged toner to the photosensitive drum 121 to develop the electrostatic latent image into a toner image. The toner image carried by the photosensitive drum 121 is transferred to the sheet P conveyed from the pair of registration rollers 136 by a bias electric field formed by the transfer charger 125. The sheet P to which the toner image is transferred is separated from the photosensitive drum 121 by a bias electric field formed by the separation charger 126 and conveyed to a fixing unit 129 by a pre-fixing conveyance unit 128. An adhering substance such as transfer residual toner remaining on the photosensitive drum 121 without being transferred to the sheet P is removed by the cleaner 127, and the photosensitive drum 121 prepares for a next image forming operation.

The sheet P conveyed to the fixing unit 129 is subjected to fixing processing including pressing and heating of the toner image while being pinched and conveyed by the pair of rollers. Accordingly, the toner is melted and then fixed, so that the image is fixed on the sheet P. In a case where image output is completed, the sheet P on which the fixed image is formed is discharged to a discharge tray 130, which projects outside from the apparatus main body 101A, via a pair of discharge rollers 40. In a case where an image is to be formed on a back surface of the sheet P in double-sided printing, a front surface and the back surface of the sheet P passed through the fixing unit 129 are reversed by a reversing unit 139, and the sheet P is conveyed to a pair of registration rollers 136 by a double-sided conveyance unit 140. Then, the sheet P on which an image is formed again by the image forming unit 133 is discharged to the discharge tray 130.

The above-described image forming unit 133 is an example of an image forming unit, and, for example, an ink-jet method image forming unit or an offset printing method printing mechanism can be used as an image forming unit.

### <Configuration of Image Reading Apparatus 103>

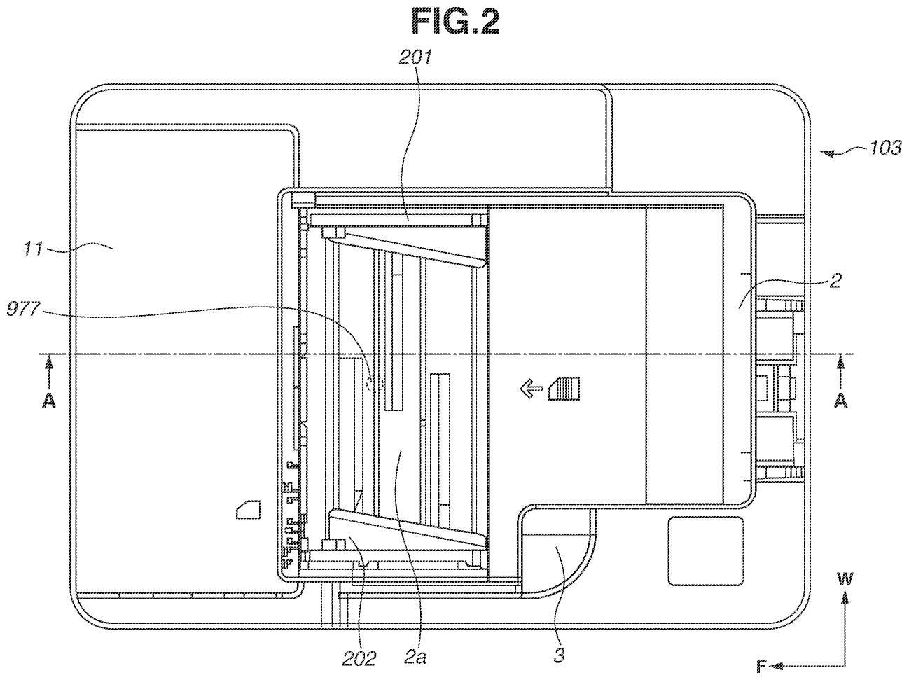

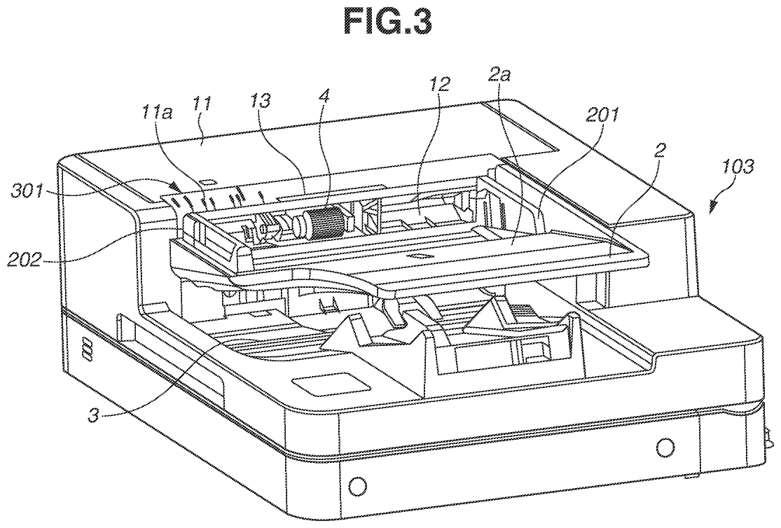

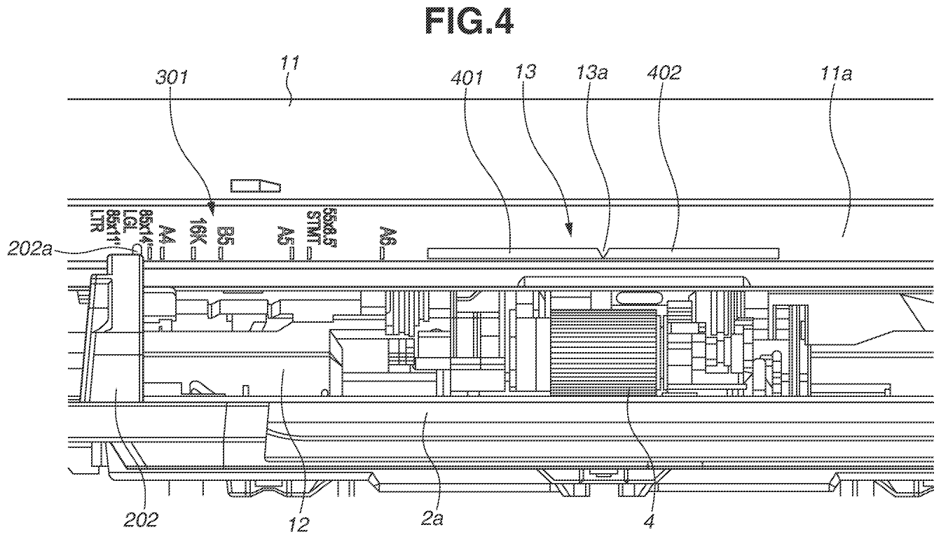

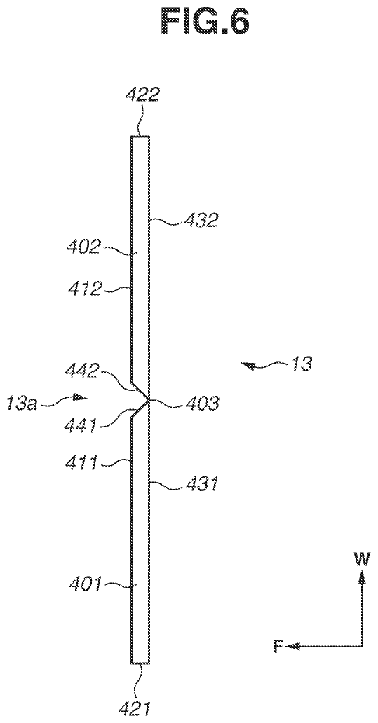

A schematic configuration of the image reading apparatus 103 is described with reference to FIGS. 2 to 6. FIGS. 2 and 3 are respectively a top view and a perspective view of the image reading apparatus 103. FIG. 4 illustrates a setting position indication portion and a size index provided on an opening/closing cover, which is viewed along a feeding direction. FIG. 5 is a cross-sectional view of the image reading apparatus 103 (a cross-sectional view of taken along a line A-A line in FIG. 2). FIG. 6 is an enlarged view of the setting position indication portion.

The dimensions, materials, shapes, and relative arrangements of components described in the following exemplary embodiments should not be construed to restrict the scope of the present disclosure thereto unless otherwise specified.

As illustrated in FIG. 5, the image reading apparatus 103 includes the scanner unit 20 and the ADF 1. The image reading apparatus 103 includes a first reading unit 14 arranged in the scanner unit 20 and a second reading unit 15 arranged in the ADF 1.

The first reading unit 14 and the second reading unit 15 form a double-sided reading unit E that can read both surfaces of the document D as a sheet to be conveyed by the ADF 1. The first reading unit 14 arranged in the scanner unit 20 reads image information on a first surface of the document D. The second reading unit 15 reads image information on a second surface of the document D opposite to the first surface.

The first reading unit 14 and the second reading unit 15 each include a light source including a light emitting diode (LED) array arranged in a main scanning direction perpendicular to a conveyance direction of the document D and a plurality of light receiving elements also arranged in the main scanning direction. Light emitted from the LED array, and reflected by the document D, forms an image on each light receiving element via the lens and is photoelectrically converted by the light receiving element.

The scanner unit 20 is fixed on an upper surface of the apparatus main body 101A (refer to FIG. 1). On an upper surface of the scanner unit 20, a document platen 31 of a flatbed type is arranged as illustrated in FIG. 5. The first reading unit 14 is supported by a carriage (not illustrated) that can move in a right-and-left direction in FIG. 5 and can move along the document platen 31 over an entire length of the document platen 31.

The ADF 1 is supported by a not illustrated hinge mechanism arranged at a depth side of the scanner unit 20 to be able to open and close in a vertical direction with respect to the scanner unit 20.

The ADF 1 includes a document tray 2 having a placement surface 2a on which (i.e., the upper surface thereof) a document is placed, a document conveyance unit 12, and a document discharge unit 3. The document tray 2 supports the document D placed thereon by a user. The document conveyance unit 12 includes a document conveyance path formed inside thereof and feeds the document D placed on the document tray 2 to the double-sided reading unit E along the document conveyance path. An image on the document D fed from the document conveyance unit 12 is read by the double-sided reading unit E, and the document D is discharged to the document discharge unit 3.

The document conveyance unit 12 includes a pickup roller 4 as a feeding unit, a feed roller 5, a retard roller 6, a pair of registration rollers 7, pairs of conveyance rollers 8 and 9, and a pair of discharge rollers 10. An opening/closing cover 11 is attached to the document conveyance unit 12 to be freely rotatable about a fulcrum 11b. An inner portion of the opening/closing cover 11 is a guide for guiding a document. When the opening/closing cover 11 is opened, the document conveyance path is opened. Thus, a document stacked in the document conveyance path can be removed by opening the opening/closing cover 11.

The pickup roller 4 can move in the vertical direction with respect to the upper surface of the document tray 2 and feeds the document D on the document tray 2 in a feeding direction F by abutting thereon. The feed roller 5 conveys the document D received from the pickup roller 4 to a downstream side in the conveyance direction. The retard roller 6 is pressed to have contact with the feed roller 5, and rotational drive in a direction against the conveyance direction is input thereto via a torque limiter. Accordingly, the feed roller 5 separates the document D to be conveyed one by one.

The pair of registration rollers 7 receives a downstream end in the conveyance direction of the document D conveyed by the feed roller 5 in a state where rotation is stopped, and bends the document D to correct skew feeding. Further, the pair of registration rollers 7 transfers the document D to the pair of conveyance rollers 8. The pair of conveyance rollers 8 sends the document D to the double-sided reading unit E and transfers it to the pair of conveyance rollers 9 on the downstream side. At that time, the image on the document D is read by the first reading unit 14 and the second reading unit 15. The pair of conveyance rollers 9 transfers the document D passing through the double-sided reading unit E to the pair of discharge rollers 10. The pair of discharge rollers 10 discharges the document D to the document discharge unit 3.

The document tray 2 is provided with a first side regulating plate 201 and a second side regulating plate 202, which can freely move in a width direction W (refer to FIGS. 2 and 3). The first side regulating plate 201 and the second side regulating plate 202 abut on both sides of the document placed on the placement surface 2a of the document tray 2 in the width direction W, and regulate a position of the document. The width direction W as a sheet width direction is a direction perpendicular to the main scanning direction in which the first reading unit 14 and the second reading unit 15 as reading units read the image on the document D, namely the feeding direction F.

The first side regulating plate 201 and the second side regulating plate 202 are configured to move in conjunction with each other by an interlocking mechanism including a pinion gear 977 arranged inside the document tray 2 so that when a user moves one of the first side regulating plate 201 and the second side regulating plate 202 in the width direction W, the other moves in an opposite direction by a same distance. In other words, the first side regulating plate 201 and the second side regulating plate 202 are moved in the width direction W by the pinion gear 977, while maintaining a distance in the width direction W from a predetermined position (hereinbelow, referred to as a conveyance center) to the first side regulating plate 201 and a distance in the width direction W from the conveyance center to the second side regulating plate 202 constant. A set position and an orientation of the document D set on the placement surface 2a of the document tray 2 are determined by, for example, operating the second side regulating plate 202 by a user.

As illustrated in FIGS. 3 and 4, the opening/closing cover 11 is provided with a size index 301 and a setting position indication portion 13 on an inclined portion 11a at an upstream end portion in the feeding direction F thereof to enable a user to recognize a size of standard paper. The size index 301 and the setting position indication portion 13 are provided at positions different from the placement surface 2a so that the size index 301 and the setting position indication portion 13 on the inclined portion 11a and the document placed on the placement surface 2a can be visually recognized at the same time. According to the present exemplary embodiment, the size index 301 and the setting position indication portion 13 are printed on the inclined portion 11a of the opening/closing cover 11, which is located above a downstream side portion of the placement surface 2a. Therefore, the size index 301 and the setting position indication portion 13 on the inclined portion 11a, which is inclined with respect to a horizontal plane, and the placed document can be visually recognized at the same time, when viewed from above as indicated by an arrow H in FIG. 5.

As illustrated in FIG. 4, the second side regulating plate 202 as a regulating member is provided with a convex portion 202a as an indicating portion at a position corresponding to the size index 301. The size index 301 includes a plurality of character strings indicating sizes of the standard paper. In a case where the first and the second side regulating plates 201 and 202 are placed at positions corresponding to the both sides of the placed document in the width direction W, the convex portion 202a is disposed to indicate the character string representing the size of the placed document in the plurality of character strings included in the size index 301. Therefore, a user can check the size of the document based on the character string on the size index 301 indicated by the convex portion 202a on the second side regulating plate 202. As described above, a user can recognize the size of the document by the size index 301 on the opening/closing cover 11 indicated by the convex portion 202a. In addition, in a case where a user already knows the size of the document, the user moves the second side regulating plate 202 to a position corresponding to the known size based on the size index 301. In this state, the user can easily recognize that the user only has to set the document between the first side regulating plate 201 and the second side regulating plate 202, in other words, to set the document by aligning the both sides in the width direction W thereof along the first side regulating plate 201 and the second side regulating plate 202.

As described above, in a case where documents having the same size in the width direction W are to be collectively set, the document size and the document set position are clarified by operating the second side regulating plate 202.

For example, in a case where a plurality of documents having sizes different from each other in the width direction W (hereinbelow, referred to as non-standard size mixed documents) is set, a set position of the document having a maximum size is clear in the documents to be set since both sides thereof abut on the first and the second side regulating plates 201 and 202. On the other hand, in a case where the non-standard size mixed documents are set, there is a concern that it is difficult to recognize which position to set the document having a size smaller than the maximum size in the documents to be set. According to the present exemplary embodiment, the setting position indication portion 13 is provided to deal with the concern. The setting position indication portion 13 is described below with reference to FIG. 6.

The setting position indication portion 13 includes a first width display portion 401 as a first portion and a second width display portion 402 as a second portion, both of which extend in the width direction W.

The first width display portion 401 includes a first upstream line 431 extending by a predetermined length in the width direction W and a first downstream line 411 arranged on the downstream side of the first upstream line 431 in the feeding direction F and extending in the width direction W. The first width display portion 401 further includes a first end line 421 located on an outermost side in the width direction W and extending in the feeding direction F and a first inclined line 441 located on an inside in the width direction W. In the first width display portion 401, an area surrounded by the first upstream line 431, the first downstream line 411, the first end line 421, and the first inclined line 441 has color different from that of a background, so that the first width display portion 401 can be easily checked.

The second width display portion 402 includes a second upstream line 432 extending by a predetermined length in the width direction W and a second downstream line 412 arranged on the downstream side of the second upstream line 432 in the feeding direction F and extending in the width direction W. The second width display portion 402 further includes a second end line 422 located on the outermost side in the width direction W and extending in the feeding direction F and a second inclined line 442 located on the inside in the width direction W. In the second width display portion 402, an area surrounded by the second upstream line 432, the second downstream line 412, the second end line 422, and the second inclined line 442 has color different from that of the background.

The first inclined line 441 and the second inclined line 442, which are inclined to the outside in the width direction W toward the downstream side in the feeding direction F intersect with each other at an intersection point 403. In other words, the first inclined line 441 and the second inclined line 442 are inclined to become distant from a center position toward the downstream side in the feeding direction F and intersect with each other at the respective upstream end portions. The setting position indication portion 13 displays the intersection point 403 so that a user can recognize the center position of the document placed on the placement surface 2a in the width direction W by the intersection point 403. Specifically, the first inclined line 441, the second inclined line 442, and the intersection point 403 form a setting center guide portion 13a for guiding a user to the center position. In other words, an area combining the first width display portion 401 and the second width display portion 402 has a substantially rectangular shape that is notched at the setting center guide portion 13a indicating the center position in the width direction W.

The first width display portion 401 and the second width display portion 402 have a shape symmetrical with respect to the intersection point 403 (namely, the center position of the document to be placed) in the width direction W.

A distance from the first end line 421, which is an end of the first width display portion 401 on one side in the width direction W, to the second end line 422, which is an end of the second width display portion 402 on the other side in the width direction W, is the same as a width of a document having a minimum size in the width direction W that can be read, namely can be fed by the image reading apparatus 103. The minimum size of the document that can be read by the image reading apparatus 103 means a minimum size in a specification of the image reading apparatus 103.

A position of the intersection point 403 in the width direction W (namely, the center position of the document indicated by the setting center guide portion 13a) coincides with a center of the pickup roller 4 in the width direction W.

A document setting based on the setting position indication portion 13 and an action and an effect of the setting position indication portion 13 are described below.

In a case where the non-standard size mixed documents are collectively set, a user moves a pair of the first and the second side regulating plates 201 and 202 to positions corresponding to the maximum size in the width direction W of a document in the non-standard size mixed documents to be set. The document D having the size other than the maximum size of the document in the non-standard size mixed documents is set so that the center of the document D in the width direction W matches the center position indicated by the setting center guide portion 13a. A presence of the setting center guide portion 13a improves capability of setting as compared with a case where the setting center guide portion 13a is not provided.

The first and the second width display portions 401 and 402 extend symmetrically by the same length in the width direction W with respect to the setting center guide portion 13a. In other words, a distance from the center position of the document placed on the placement surface 2a to the end of the first width display portion 401 (i.e., the first end line 421) on one side is the same as a distance from the center position of the document placed on the placement surface 2a to the end of the second width display portion 402 (i.e., the second end line 422) on the other side. Therefore, the document can be set so that a distance from the end of the document D to be set on one side in the width direction W to the first end line 421 of the first width display portion 401 is the same as a distance from the end of the document D on the other side in the width direction W to the second end line 422 of the second width display portion 402. Accordingly, the document can be easily set by matching the center of the document in the width direction W with the center of the pickup roller 4 in the width direction W. The center of the document in the width direction W is matched with the center of the pickup roller 4 in the width direction W, and thus stable feeding of the document can be realized while skew during feeding is suppressed.

A total length of the first and the second width display portions 401 and 402 in the width direction W is set to a length corresponding to a width of the document having the minimum size that can be handled (guaranteed) by the image reading apparatus 103. Thus, a user can check whether a width of the placed document is more than or equal to the guaranteed minimum width of the document based on the first and the second width display portions 401 and 402 without referring to a manual of the apparatus. Accordingly, the user can reduce a risk of accidentally feeding a document of which size is unguaranteed.

As described above, even in a case where the non-standard size mixed documents are set, the image reading apparatus 103 can perform a document setting to stably feed the non-standard size mixed documents while maintaining operability in the document setting.

The case where the non-standard size mixed documents are set is described above. However, the same effect can be obtained not only in a case where the non-standard size mixed documents are set but also a case where a document is fed without operating the pair of the first and the second side regulating plates 201 and 202.

According to the above-described exemplary embodiment, the configuration is exemplified in which the conveyance center in the width direction W, the center position of the pickup roller 4, and the center position indicated by the setting center guide portion 13a coincide with one another in the width direction W. However, the present disclosure can also be applied to an apparatus in which the conveyance center is displaced from the center position of the pickup roller 4 in the width direction W. In this apparatus, the center position of the pickup roller 4 coincides with the center position of the document indicated by the setting center guide portion 13a in the width direction W, and the conveyance center is offset by a certain amount in the width direction W with respect to the center position of the document indicated by the setting center guide portion 13a. In this case, the conveyance center is an intermediate position between the first side regulating plate 201 and the second side regulating plate 202 in the width direction W, and thus the intermediate position is displaced from the center position of the document indicated by the setting center guide portion 13a in the width direction W.

According to the above-described exemplary embodiment, the setting position indication portion 13 is provided on the inclined portion 11a of the opening/closing cover 11. However, the setting position indication portion 13 can be provided on, for example, a place different from the placement surface 2a on the document tray 2 without being limited to the above-described one.

According to the above-described exemplary embodiment, the convex portion 202a is exemplified as the indicating portion provided on the second side regulating plate 202 at the position corresponding to the size index 301. However, the indicating portion is not limited to the convex portion and can be, for example, an arrow provided on the second side regulating plate 202.

The configuration is exemplified in which the distance from the first end line 421 as the end of the first width display portion 401 on one side in the width direction W to the second end line 422 as the end of the second width display portion 402 on the other side in the width direction W is the same as the width of the document having the minimum size in the width direction W that can be read by the image reading apparatus 103. However, the distance from the first end line 421 as the end of the first width display portion 401 on one side in the width direction W to the second end line 422 as the end of the second width display portion 402 on the other side in the width direction W can be set to a length that is longer than the minimum size and shorter than the maximum size. In this case, it is difficult to check whether the width of the placed document is more than or equal to the guaranteed minimum width of the document, but an effect can be exerted that the center of the document in the width direction W can be easily set to match the center of the position where the document to be placed in the width direction W.

The first width display portion 401 and the second width display portion 402 illustrated in FIG. 6 are exemplified as the setting position indication portion 13, and a modification of the setting position indication portion is described below.

The configuration is exemplified in which the area, as the first width display portion 401, surrounded by the first upstream line 431, the first downstream line 411, the first end line 421, and the first inclined line 441 has the color different from that of the background. However, the first width display portion 401 can be formed by the first upstream line 431, the first downstream line 411, the first end line 421, and the first inclined line 441, all of which have a color different from that of the background, and a color of an internal area surrounded by these lines can be the same as the background color.

The configuration is exemplified in which the area, as the second width display portion 402, surrounded by the second upstream line 432, the second downstream line 412, the second end line 422, and the second inclined line 442 has the color different from that of the background. However, the second width display portion 402 can be formed by the second upstream line 432, the second downstream line 412, the second end line 422, and the second inclined line 442, all of which have a color different from that of the background, and a color of an internal area surrounded by these lines can be the same as the background color.

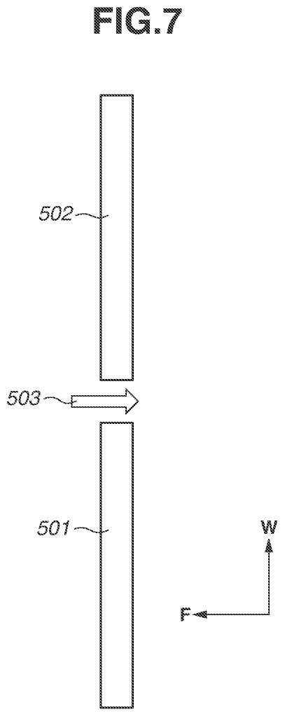

The configuration, in which the center position of the document is indicated by the intersection point 403 of the first inclined line 441 of the first width display portion 401 and the second inclined line 442 of the second width display portion 402, both of which extend in the width direction W, is exemplified with reference to FIG. 6. However, as illustrated in FIG. 7, a center mark 503 indicating the center position of the document can be provided separately from a first width display portion 501 and a second width display portion 502, both of which extend in the width direction W.

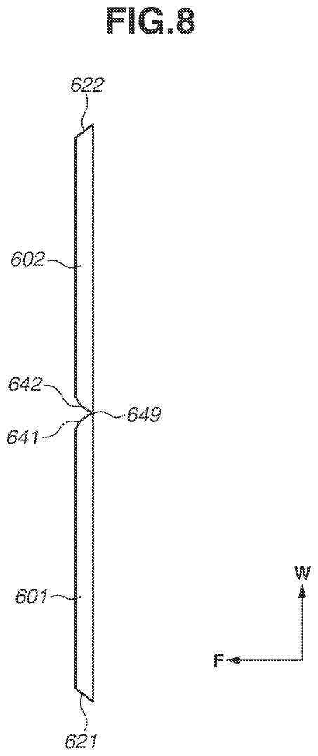

The configuration, in which the first end line 421 of the first width display portion 401 and the second end line 422 of the second width display portion 402 are parallel to the feeding direction F and the first inclined line 441 of the first width display portion 401 and the second inclined line 442 of the second width display portion 402 have linear shapes, is exemplified with reference to FIG. 6. However, the present disclosure can adopt, for example, a configuration as illustrated in FIG. 8. Specifically, an outer end 621 in the width direction W of a first width display portion 601 can be inclined with respect to the feeding direction F. An outer end 622 in the width direction W of a second width display portion 602 can be inclined with respect to the feeding direction F. An inner end in the width direction W of the first width display portion 601 can be an inclined line 641 having a circular arc shape. An inner end in the width direction W of the second width display portion 602 can be an inclined line 642 having a circular arc shape. Further, the center position of the document to be placed is indicated by an intersection point 649 of the inclined line 641 and the inclined line 642.

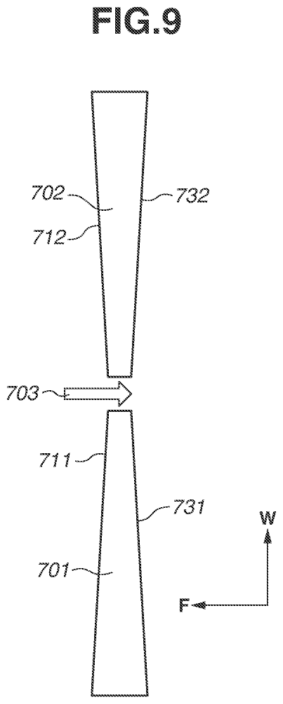

The configuration, in which the first upstream line 431 and the first downstream line 411 of the first width display portion 401 and the second upstream line 432 and the second downstream line 412 of the second width display portion 402 are all straight lines parallel to the width direction W, is exemplified with reference to FIG. 6. However, for example, as illustrated in FIG. 9, a first upstream line 731 and a first downstream line 711 of a first width display portion 701 and a second upstream line 732 and a second downstream line 712 of a second width display portion 702 can be inclined with respect to the width direction W. In FIG. 9, a center mark 703 indicates the center position of the document.

In any of the modifications in FIGS. 7 to 9, a length of the first width display portion and a length of the second width display portion are the same in the width direction W.

According to the above-described exemplary embodiment, the setting position indication portion 13 is printed on the opening/closing cover 11.

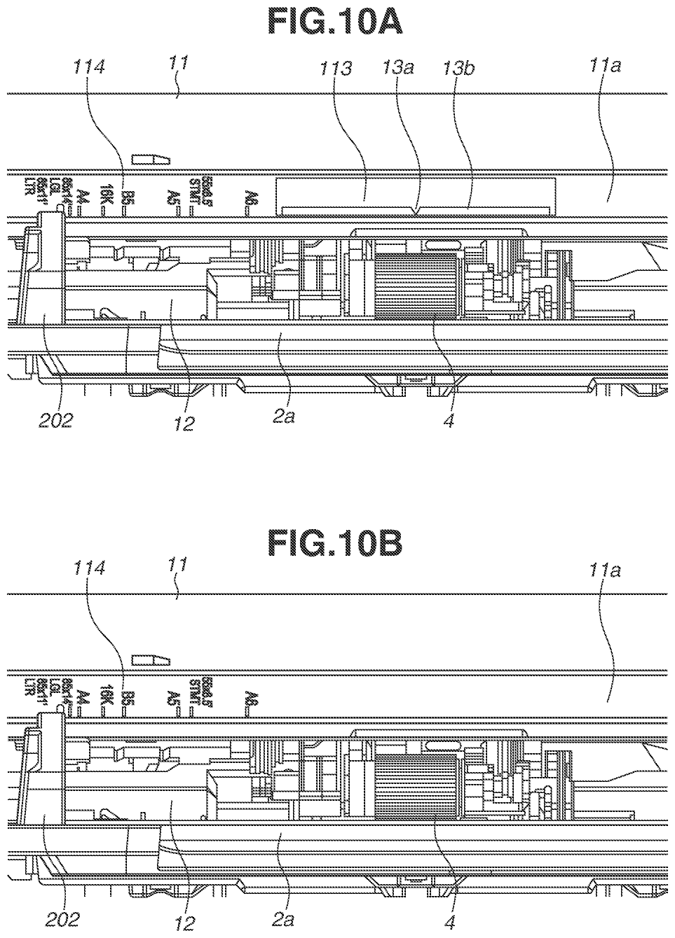

However, instead of printing the setting position indication portion 13 on the opening/closing cover 11, for example, a label including the setting position indication portion 13 can be attached to the opening/closing cover 11. In other words, a setting position indication label 113 including the setting position indication portion 13 can be prepared as a separate component and can be selectively attached to each apparatus. Accordingly, it becomes easier to respond to each user in such a manner that the setting position indication label 113 is attached to the opening/closing cover 11 only for a user who collectively scans non-standard size documents and is not attached thereto for other users. The configuration can avoid confusion in an operation caused by a presence of the setting position indication portion 13 for a user who does not collectively read the non-standard size documents. FIGS. 10A and 10B are enlarged views respectively illustrating a case where the setting position indication label 113 is attached to the opening/closing cover 11 and a case where the setting position indication label 113 is not attached to the opening/closing cover 11.

In the modification illustrated in FIG. 10A, the setting position indication label 113 is a separate component. A size index 114 can be selectively attached to each apparatus (for each user) as a separate component.

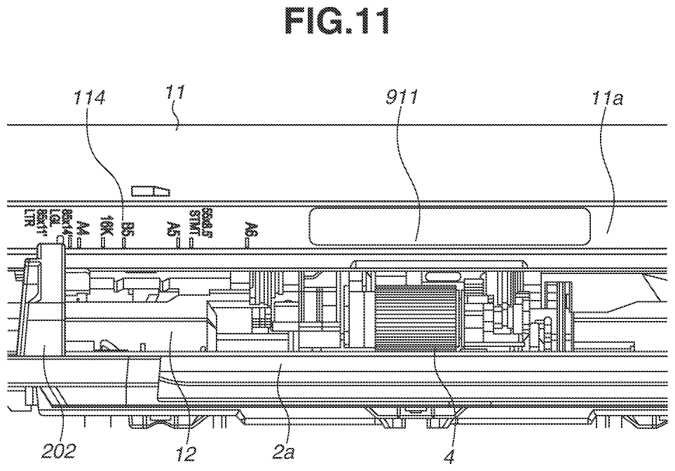

In a configuration in which both of the setting position indication portion 13 and the size index 114 are printed on the opening/closing cover 11, a concealing label (a concealing sheet) can be attached to the setting position indication portion 13 and the size index 114. Either of the setting position indication portion 13 and the size index 114 can be disabled by selectively attaching the concealing label (the concealing sheet) to each apparatus. In FIG. 11, a concealing label (a concealing sheet) 911 is attached to the setting position indication portion 13. Accordingly, confusion in the operation caused by the presence of the setting position indication portion 13 can be avoided for a user who does not collectively read the non-standard size documents.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-086985, filed May 18, 2020, which is hereby incorporated by reference herein in its entirety.

What is claimed is:

1. An image reading apparatus comprising:
a placement surface on which a sheet is to be placed;
a feeding unit configured to feed the sheet placed on the placement surface in a feeding direction;
a reading unit configured to read an image on the sheet fed by the feeding unit; and
an indication portion provided at a position different from the placement surface and configured to indicate a position at which the sheet is to be placed on the placement surface,
wherein the indication portion indicates a center position of the sheet to be placed on the placement surface in a sheet width direction perpendicular to the feeding direction,
wherein the indication portion includes a first portion extending in the sheet width direction on one side in the sheet width direction of the center position and a second portion extending in the sheet width direction on another side in the sheet width direction of the center position, and
wherein a distance from the center position to an end of the first portion on the one side is the same as a distance from the center position to an end of the second portion on the other side.

2. The image reading apparatus according to claim 1,
wherein the first portion extends by a predetermined length in the sheet width direction, and
wherein the second portion extends by the predetermined length in the sheet width direction.

3. The image reading apparatus according to claim 1, wherein the first portion and the second portion have a shape symmetrical with respect to the center position in the sheet width direction.

4. The image reading apparatus according to claim 1, wherein a distance from the end of the first portion on the one side to the end of the second portion on the other side in the sheet width direction is less than a width of a sheet having a maximum size in the sheet width direction that can be fed by the image reading apparatus.

5. The image reading apparatus according to claim 1, wherein a distance from the end of the first portion on the one side to the end of the second portion on the other side in the sheet width direction is same as a width of a sheet having a minimum size in the sheet width direction that can be fed by the image reading apparatus.

6. The image reading apparatus according to claim 1, wherein the indication portion is provided on a cover so that a user can visually recognize the sheet placed on the placement surface and the indication portion at the same time.

7. The image reading apparatus according to claim 6, wherein the cover is rotatably supported.

8. The image reading apparatus according to claim 6,
wherein the cover includes an inclined portion that is inclined with respect to a horizontal plane above a part on a downstream side of the placement surface in the feeding direction, and
wherein the indication portion is provided on the inclined portion.

9. The image reading apparatus according to claim 1, wherein an area combining the first portion and the second portion of the indication portion has a substantially rectangular shape that is notched at a portion indicating the center position.

10. The image reading apparatus according to claim 1, wherein the indication portion indicates the center position by an intersection point of two inclined lines.

11. The image reading apparatus according to claim 1,
wherein the first portion includes a first inclined line that is inclined to become distant from the center position toward a downstream side in the feeding direction,
wherein the second portion includes a second inclined line that is inclined to become distant from the center position toward the downstream side in the feeding direction, and
wherein the indication portion indicates the center position by an intersection point of the first inclined line and the second inclined line.

12. The image reading apparatus according to claim 1, further comprising:
a regulating member configured to freely move in the sheet width direction and to regulate a position of an end of the sheet placed on the placement surface in the sheet width direction; and
a size index configured to display a size of the sheet by indication using an indicating portion provided on the regulating member.

13. The image reading apparatus according to claim 1,
wherein the feeding unit includes a pickup roller, and
wherein the center position indicated by the indication portion in the sheet width direction is a position corresponding to a center of the pickup roller in the sheet width direction.

14. The image reading apparatus according to claim 13, further comprising a pair of regulating units movable in the sheet width direction and configured to regulate positions on both sides of the sheet placed on the placement surface in the sheet width direction,
wherein an intermediate position of the pair of regulating units and the center of the pickup roller in the sheet width direction coincide with each other in the sheet width direction.

15. The image reading apparatus according to claim 13, further comprising a pair of regulating units movable in the sheet width direction and configured to regulate positions on both sides of the sheet placed on the placement surface in the sheet width direction,
wherein an intermediate position of the pair of regulating units and the center of the pickup roller in the sheet width direction are displaced from each other in the sheet width direction.

16. The image reading apparatus according to claim 1, wherein the indication portion is provided on a label to be attached to the image reading apparatus.

17. The image reading apparatus according to claim 1, further comprising a concealing sheet configured to conceal the indication portion.

18. An image reading apparatus comprising:
a placement surface on which a sheet is to be placed;
a feeding unit configured to feed the sheet placed on the placement surface in a feeding direction;
a reading unit configured to read an image on the sheet fed by the feeding unit;
a regulating member movable in a sheet width direction perpendicular to the feeding direction and configured to regulate a position of an end of the sheet placed on the placement surface in the sheet width direction;
a size index configured to display a size of the sheet placed on the placement surface; and
an indication portion configured to indicate a position at which the sheet is to be placed on the placement surface,
wherein the indication portion indicates a center position of the sheet to be placed on the placement surface in the sheet width direction,
wherein the indication portion includes a first portion extending by a predetermined length in the sheet width direction on one side in the sheet width direction of the center position and a second portion extending by the predetermined length in the sheet width direction on another side in the sheet width direction of the center position, and
wherein a distance from the center position to an end of the first portion on the one side is the same as a distance from the center position to an end of the second portion on the other side.

19. The image reading apparatus according to claim 18,
wherein the feeding unit includes a pickup roller, and
wherein the center position indicated by the indication portion in the sheet width direction is a position corresponding to a center of a feeding roller in the sheet width direction.

20. An image forming apparatus comprising:
a placement surface on which a sheet is to be placed;
a feeding unit configured to feed the sheet placed on the placement surface in a feeding direction;
a reading unit configured to read an image on the sheet fed by the feeding unit;
an indication portion provided at a position different from the placement surface and configured to indicate a position at which the sheet is to be placed on the placement surface; and
an image forming unit configured to form an image on a recording medium based on the image read by the reading unit,
wherein the indication portion indicates a center position of the sheet to be placed on the placement surface in a sheet width direction perpendicular to the feeding direction,
wherein the indication portion includes a first portion extending in the sheet width direction on one side in the sheet width direction of the center position and a second portion extending in the sheet width direction on another side in the sheet width direction of the center position, and
wherein a distance from the center position to an end of the first portion on the one side is the same as a distance from the center position to an end of the second portion on the other side.
